(19) United States
(12) Patent Application Publication
(10) Pub. No.: US 2007/0069524 A1
(43) Pub. Date: Mar. 29, 2007

(54) Locking mechanism of braking device for aluminum doors and windows

(76) Inventor: Chen-Feng Lin, Jhonghe City (TW)

Correspondence Address: Troxell Law Office Pllc, Suite 1404, 5205 Leesburg Pike, Falls Church, VA, 22041, US

(21) Appl. No.: 11/224,931

(22) Filed: Sep. 14, 2005

(51) Int. Cl. E05C 1/10

(52) U.S. Cl. 292/175

(57) ABSTRACT

A locking mechanism of a braking device for aluminum doors and window according to the invention includes a sleeve and a locking pillar. The sleeve is a hollow tube-shaped structure, which has an expanded projecting rim at an upper end surface thereof, and a fastening mechanism below the projecting rim. The locking pillar has a fastening section at an outer wall thereof for corresponding with the fastening mechanism of the sleeve to accommodate the locking pillar in the sleeve and to further accommodate the sleeve in a through opening at a supporting window frame of a casement, thereby locating a securing section of the sleeve to the through opening at an upper board of the supporting window frame. Hence, the locking pillar is allowed with sliding movements in the sleeve without being bounced out or disengaged.

### BACKGROUND OF THE INVENTION

(a) Field of the Invention

The invention relates to a locking mechanism of a braking device for aluminum doors and windows, and more particularly to a locking mechanism of a braking device for aluminum doors and windows, in that the locking mechanism is suitable for combined sliding and pivot aluminum doors and windows, thereby restraining sliding-across effects when the windows are pushed out without disengaging the locking mechanism.

(b) Description of the Prior Art

Aluminum doors and windows are extensively applied to buildings; and are classified into three types including sliding, pivot, and combined sliding and pivot. Wherein, the combined sliding and pivot type integrates advantages of the sliding and pivot types, and are thus capable of providing larger opened spaces and more diverse designs of opened windows while also reducing a quantity of studs required. In order to prevent the combined aluminum doors and windows from sliding across due to strong winds when outwardly opened, the combined aluminum doors and windows are generally designed with a locking mechanism at a supporting window frame thereof to secure a main window. Referring to the U.S. Pat. No. 6,276,092 showing a prior locking mechanism, a lock hole is provided at a sash support frame of an outer window frame. The hole is installed with a sleeve therein. The sleeve is accommodated around a locking key having a screw at a lower surface thereof, with the screw pressing against a transmission bar. Using the screw, pressing forces of brake lining of a braking device are made adjustable. In addition, a spring is devised below the transmission bar. Thus, when the pivot window is pulled and restored, the locking key is pressed against the transmission bar, such that the brake lining is disengaged from a window groove due to leverage of the transmission bar and the window is pulled to slide horizontally. Vice versa, when the pivot window is pushed to open outwardly, the transmission bar is pressed by elastic restoring forces of the spring, such that the brake lining interlocked with the transmission bar is stopped at a lower groove to immobilize rollers. The aforesaid prior invention is indeed capable of keeping the window stationary when the window is outwardly opened. However, when the window is abruptly pushed outward, instantaneous restoring forces of the spring is likely to cause the locking key to bounce out of the sleeve or even fall downstairs to result in accidents. The prior invention is still considered rather inadequate.

Therefore, it is vital task of the invention as how to overcome the aforesaid drawback by providing a locking mechanism of a braking device according to the invention.

### SUMMARY OF THE INVENTION

The primary object of the invention is to provide a locking mechanism of a braking device for aluminum doors and windows, in that the locking mechanism is securely positioned to a lower supporting frame of a casement without being disengaged by restoring forces.

To accomplish the aforesaid object, the invention comprises a sleeve and a locking pillar. The sleeve is a hollow tube-shaped structure, which has an expanded projecting rim at an upper end surface thereof; a fastening mechanism consisted of a protruding guide block at an appropriate position below the projecting rim at a tube body, wherein the guide block is extended downward to a lower end surface, such that a dented securing section is formed between the upper end surface of the guide block and the lower end surface of the projecting rim; and a dented locating channel at an interior of the guide block. Or, the fastening mechanism can be devised as an inclined hole that is gradually expanded in a downward direction. The locking pillar has a cone-shaped locking section at an upper surface thereof; a screw opening at a lower surface thereof; a screw fastened into the screw opening and being used for adjusting frictional forces of the braking device using a screwed depth thereof; a fastening section in form of a fixing section at an outer wall thereof, and for corresponding with the locating channel of the sleeve. Wherein, the fixing block is placed in the locating channel in a slidable manner. The fastening section may also have an outer wall thereof devised as an inclined plane to form the locking pillar as a cone shape that is gradually expanded in a downward direction, such that the locking section is protruding from the upper surface of the sleeve. The sleeve is accommodated in a through opening of a supporting window frame of a casement, and the securing section of the sleeve is secured at the through hole of the supporting window frame, thereby allowing sliding movements of the locking pillar in the locating channel of the sleeve without being bounced out or disengaged.

To better understand the characteristics of the invention, detailed descriptions of preferred embodiments shall be given with the accompanying drawings below.

### BRIEF DESCRIPTION OF THE DRAWINGS

FIG. 1 shows an exploded structural schematic according to the invention.

FIG. 2 shows an elevational schematic view according to the invention.

FIG. 3 shows an elevational schematic view according to the invention installed to a window frame.

FIG. 4 shows a sectional schematic view illustrating motions of the invention with a window.

FIG. 5 shows another sectional schematic view illustrating motions of the invention with a window.

FIG. 6 shows an exploded structural schematic view of another embodiment according to the invention.

FIG. 7 shows a schematic view illustrating descending movements of the locking pillar in an assembled embodiment in FIG. 6.

FIG. 8 shows a schematic view illustrating ascending movements of the locking pillar in an assembled embodiment in FIG. 6.

### DETAILED DESCRIPTION OF THE PREFERRED EMBODIMENTS

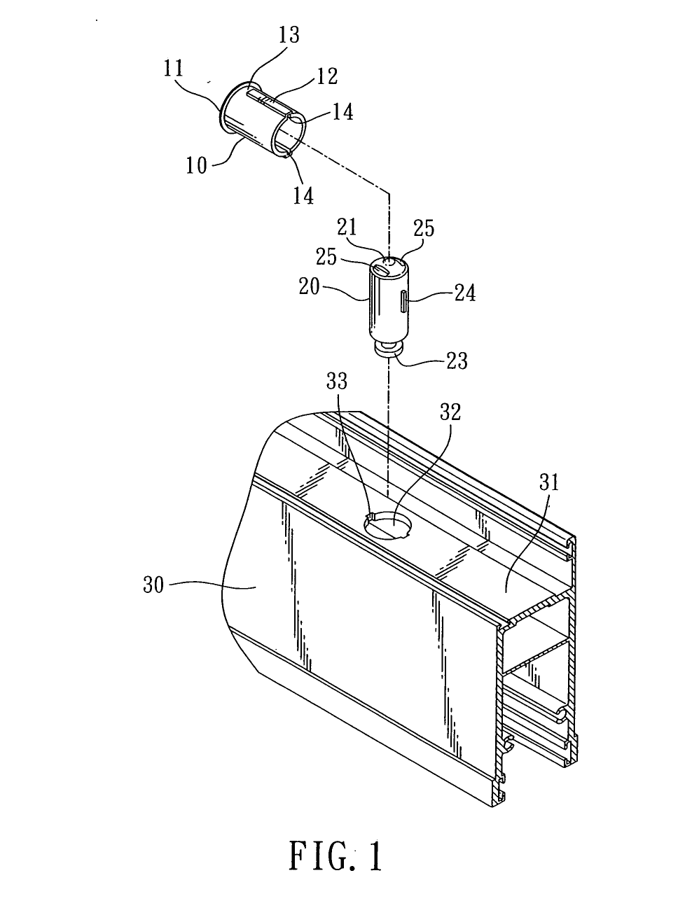

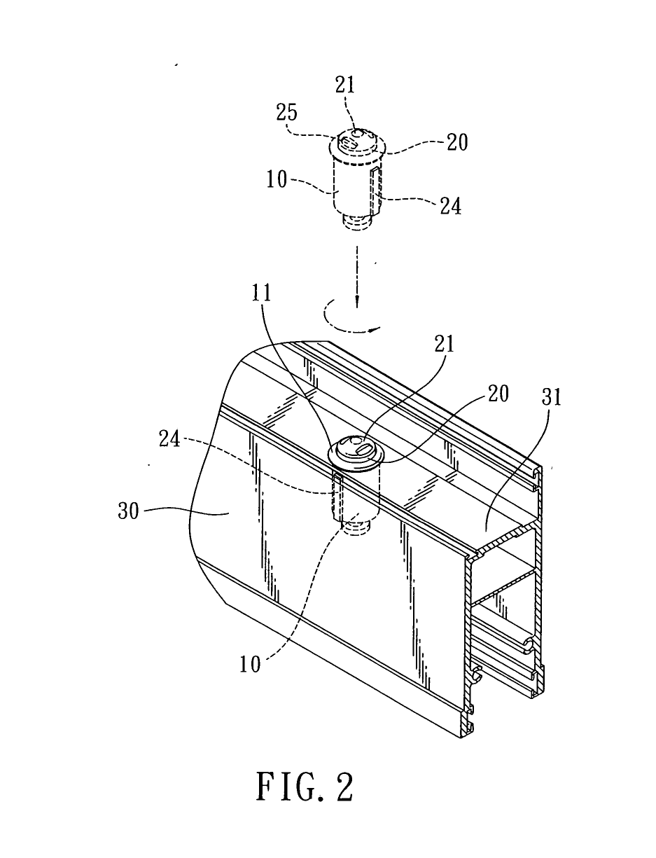

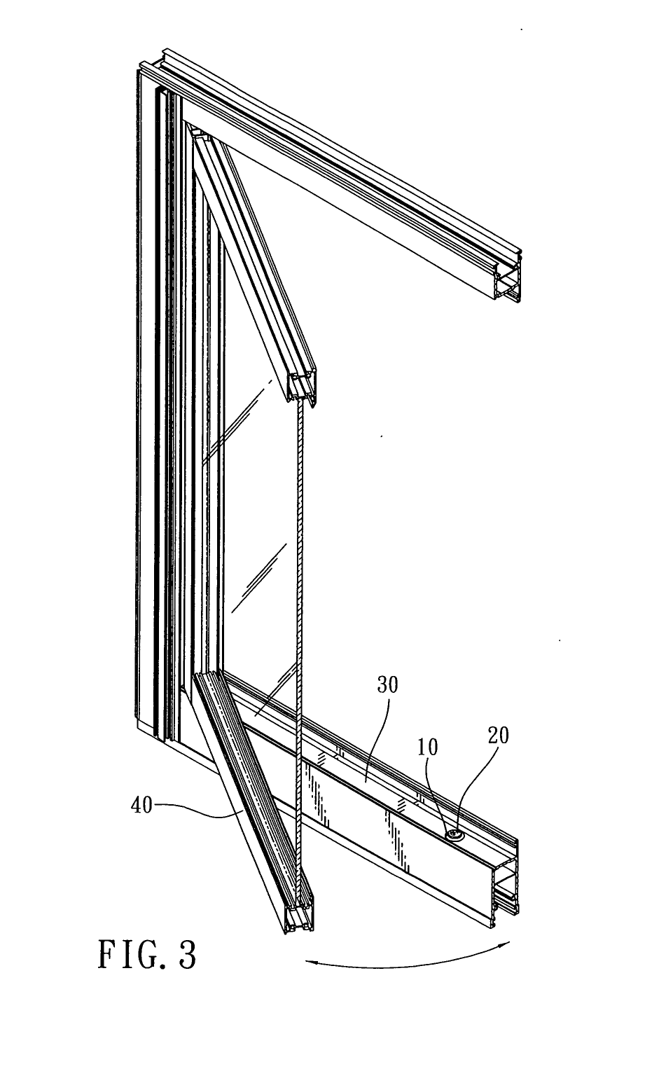

Referring to FIG. 1, FIG. 2 and FIG. 3, a locking mechanism of a braking device for aluminum doors and windows according to the invention comprises a sleeve 10, a locking pillar 20 and a supporting window frame 30 of aluminum doors and windows.

The sleeve 10 is provided with a fastening mechanism, and the locking pillar 20 is provided with a corresponding fastening section. According to the invention, the sleeve 10 is a hollow tube-shaped structure, which has an expanded projecting rim 11 at an upper end surface thereof; at least a protruding guide block 12 at an appropriate position below the projecting rim 11 at a tube body, wherein the guide block 12 is extended downward to a lower end surface, such that a dented securing section 13 is formed between the upper end surface of the guide block 12 and the lower end surface of the projecting rim 11; and a dented locating channel 14 at an interior of the guide block 12.

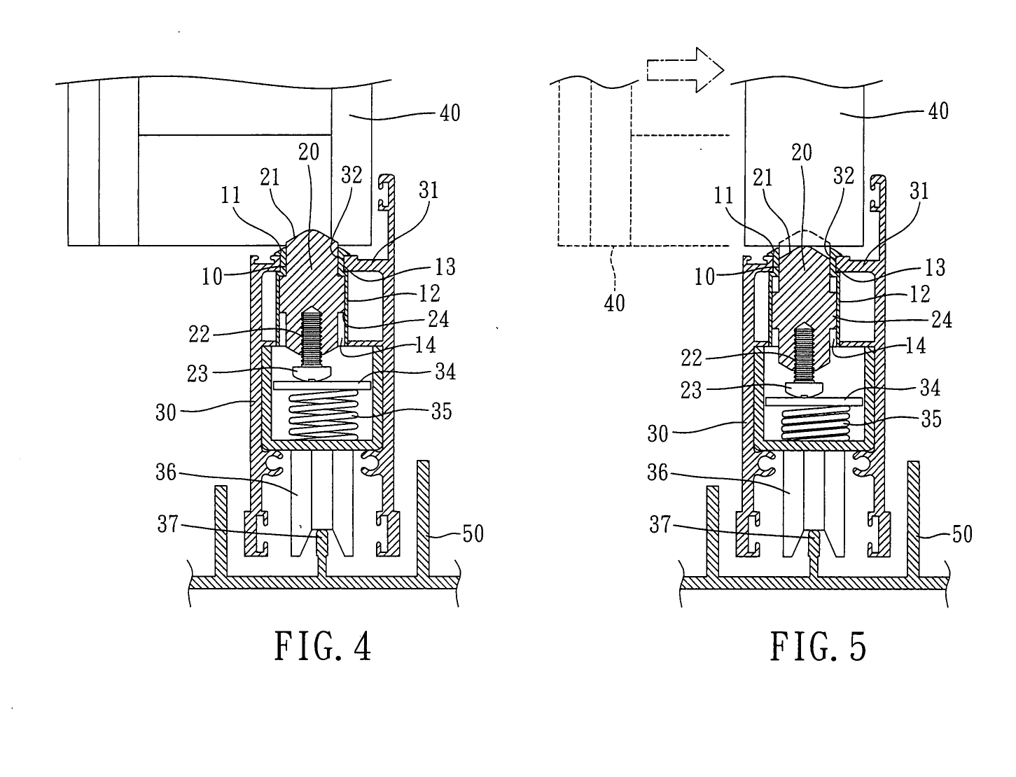

The locking pillar 20 has a cone-shaped locking section 21 at an upper surface thereof; a screw opening 22 at a lower surface thereof as shown in FIG. 4 and FIG. 5; a screw 23 fastened into the screw opening 22 and being used for adjusting frictional forces of the braking device using a screwed depth thereof; a fixing block 24 as the fastening section at an outer wall thereof, and for corresponding with the locating channel 14 of the sleeve 10; and breached sections 25 at an inner wall of the locking section 21 for facilitating picking up by a clamp.

For assembly, the fixing block 24 of the locking pillar 20 is accommodated using upward sliding movements into the locating channel 14 of the sleeve 10, to an extent that the locking section 21 is protruding from the upper surface of the sleeve 10. The supporting window frame 30 of a casement has an upper board 31 provided with a through opening 32, and at least a notch 33 at an inner wall of the through opening 32. The notch 33 and the guiding block 12 of the sleeve 10 are corresponding concave and convex bodies. The guiding block 12 of the sleeve 10 is embedded in a downward direction into the supporting window frame 30 by aligning with the notch 33 at the through opening 32, followed by being turned into the sleeve 10, such that the securing section 13 is fastened to a position of the upper board 31 without the notch 33. Thus, the locking pillar 20 is allowed with ascending and descending movements in the sleeve 10 without being disengaged.

Referring to FIG. 3, FIG. 4 and FIG. 5 showing the invention being installed to the upper board 31 of the supporting window frame 30 of a combined pivot and sliding aluminum door and window, when a main window 40 is pulled inward to close, the locking pillar 20 is pressed to force a lower edge of the main window to press downward on a compressing plate 34, resulting in a brake lining (not shown) at the other end of the compressing plate 34 to upwardly disengage from a lower window track 37, thereby allowing the main window to slide across a lower window frame 50 as shown in FIG. 5. When the main window 40 is pushed outward to open, a spring 35 below the locking pillar 20 produces restoring forces to propel the compressing plate 34 upward and to drive the locking pillar 20 to spring upward as well. For that the fixing block 24 of the locking pillar 20 is accommodated in the locating channel 14 of the sleeve 10, the locking pillar 20 remains still and is not sprung to disengage from the through opening 32 by the restoring forces. Meanwhile, the brake lining (not shown) at the other end of the compressing plate 34 is stopped at the lower window track 37, thereby immobilizing a roller 36 and accomplishing braking effects.

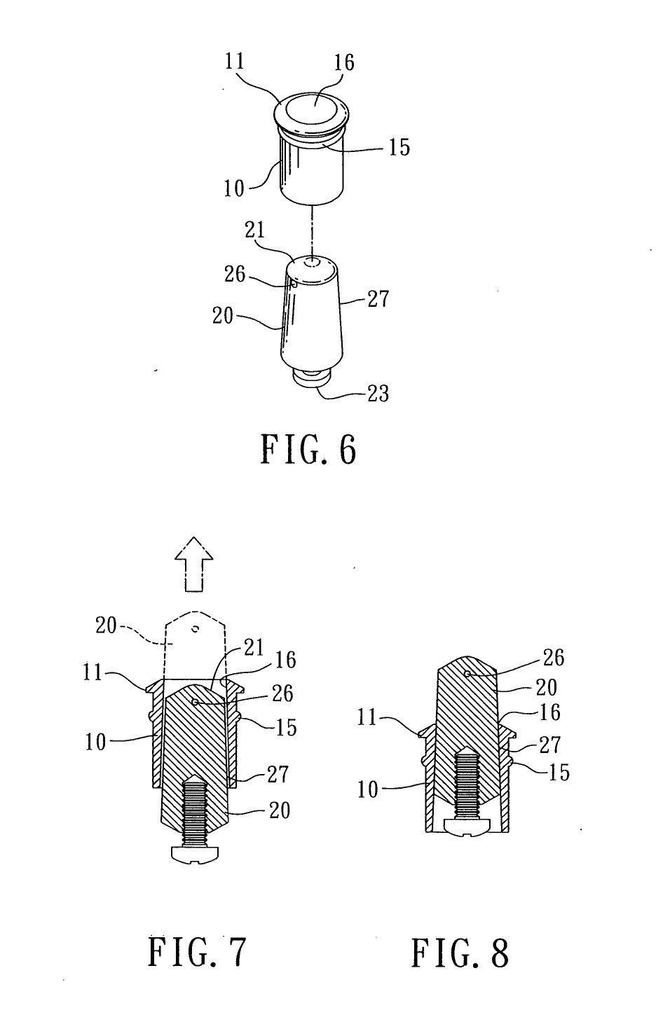

Referring to FIG. 6, FIG. 7 and FIG. 8 showing another embodiment according to the invention, the fastening mechanism of the sleeve 10 and the fastening section of the locking pillar 20 are devised with other designs. The sleeve 10 has a lower end of the expanded projecting rim 11 provided with a loop-shaped rib 15, and the securing section 13 is formed between the loop-shaped rib 15 and the projecting rim 11. In addition, the sleeve 10 has an inner hole thereof provided as an inclined hole 16, which is gradually expanded in a downward direction. The locking pillar 20 has a through hole 26 devised at a side of the locking section 21, and an outer wall thereof provided as an inclined surface 27, such that the locking pillar 20 becomes a gradually expanded in a downward direction to form a cone shape. To prevent disengagement in an upward direction, a diameter of a lower section of the locking pillar 10 is necessarily larger than an inner diameter at an upper end of the inclined hole 16 of the sleeve 20. When the locking pillar 20 is accommodated in an upward direction into the inclined hole 16 of the sleeve 10, the rib 15 of the sleeve 10 is positioned in the through opening 32 of the lower supporting frame 30 to achieve locating effects.

Conclusive from the above, the locking mechanism of a braking device for aluminum windows and doors according to the invention accomplishes expected objects of the invention using simple structures.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A locking mechanism of a braking device comprising a sleeve and a locking pillar; and being characterized that,
the sleeve is a hollow tube-shaped structure having an expanded projecting rim at an upper end surface thereof, and a fastening mechanism below the projecting rim;
the locking pillar has a cone-shaped locking section having an inclined plane at an upper surface thereof, a fastening section at an outer wall thereof for corresponding with the fastening mechanism of the sleeve, a screw opening at a lower surface thereof, an adjustable screw fastened into the screw opening for securing the locking pillar in the sleeve without being disengaged, and
the sleeve is placed in a through opening of a supporting window frame of a casement, and the sleeve is secured in a through opening at an upper board of the supporting window frame, thereby locating the locking pillar in the sleeve.

2. The locking mechanism of a braking device for aluminum doors and windows in accordance with claim 1, wherein the sleeve has at least a protruding guide block at an outer wall of the tube-shaped body thereof, and the guide block is extended downward to a lower end surface to form a securing section between the upper end surface of the guide block and the lower end surface and is provided with a locating channel therein.

3. The locking mechanism of a braking device for aluminum doors and windows in accordance with claim 1, wherein the fastening section of the locking pillar has a protruding fixing block at an outer wall thereof, and the fixing block is positioned in the locating channel of the sleeve in a slidable manner.

4. The locking mechanism of a braking device for aluminum doors and windows in accordance with claim 2, wherein the fastening section of the locking pillar has a protruding fixing block at an outer wall thereof, and the fixing block is positioned in the locating channel of the sleeve in a slidable manner.

5. The locking mechanism of a braking device for aluminum doors and windows in accordance with claim 1, wherein the through opening of the supporting window frame of a casement is provided with at least a notch at an inner wall thereof.

6. The locking mechanism of a braking device for aluminum doors and windows in accordance with claim 2, wherein the through opening of the supporting window frame of a casement is provided with at least a notch at an inner wall thereof.

7. The locking mechanism of a braking device for aluminum doors and windows in accordance with claim 1, wherein the locking section has breached portions at an inner wall thereof.

8. The locking mechanism of a braking device for aluminum doors and windows in accordance with claim 1, wherein the locking section has a through opening at a side thereof.

9. The locking mechanism of a braking device for aluminum doors and windows in accordance with claim 1, wherein the fastening section of the sleeve is devised as an expanded projecting rim with a loop-shaped rib below, a securing section is formed between the loop-shaped rib and the projecting rim, and an inner hole of the sleeve is provided as an inclined hole that is gradually expanded in a downward direction.

10. The locking mechanism of a braking device for aluminum doors and windows in accordance with claim 1, wherein a through hole is devised at a side of the fastening section of the locking pillar to form the locking pillar as a cone shape that gradually expanded in a downward direction.
